(19) United States
(12) Patent Application Publication
(10) Pub. No.: US 2012/0002035 A1
(43) Pub. Date: Jan. 5, 2012

(54) MULTI-SPECTRAL SYSTEM AND METHOD FOR GENERATING MULTI-DIMENSIONAL TEMPERATURE DATA

(75) Inventors: Hejie Li, Clifton Park, NY (US); Nirm Velumylum Nirmalan, Niskayuna, NY (US)

(73) Assignee: General Electric Company, Schenectady, NY (US)

(21) Appl. No.: 12/827,698

(22) Filed: Jun. 30, 2010

(51) Int. Cl. H04N 7/18

(52) U.S. Cl. 348/82; 348/E07.085

(57) ABSTRACT

In one embodiment, a system includes an imaging system configured to receive an image of a gas and a surface observable through the gas from an interior of a turbine, to split the image into a first two-dimensional intensity map of wavelengths indicative of a temperature of the gas and a second two-dimensional intensity map of wavelengths indicative of a temperature of the surface, and to output signals indicative of the first and second two-dimensional intensity maps.

### BACKGROUND OF THE INVENTION

The subject matter disclosed herein relates to a multi-spectral system and method for generating two-dimensional temperature maps.

Certain gas turbine engines include a turbine having viewing ports configured to facilitate monitoring of various components within the turbine. For example, a pyrometry system may be in optical communication with the viewing ports and configured to measure the temperature of certain components within a hot gas path of the turbine. In addition, an optical monitoring system may be coupled to the viewing ports and configured to provide a two-dimensional image of the turbine components. As will be appreciated, certain combustion products species, such as water vapor and carbon dioxide, absorb and emit radiation over a wide range of wavelengths. As a result, only a fraction of wavelengths emitted by the turbine components reach the viewing ports with sufficient intensity and negligible interference for accurate measurement. Consequently, certain pyrometry and/or optical monitoring systems are configured to monitor certain wavelengths which are more likely to pass through the combustion products without significant absorption or interference.

Unfortunately, configuring a system to monitor such wavelengths typically renders the system unsuitable for monitoring gas emissions. Therefore, pyrometry and/or optical monitoring systems configured to monitor turbine components may be unable to determine gas temperature within the turbine. Furthermore, intrusive temperature measurement, such as via thermocouples disposed in the hot gas path, may obstruct the flow of gas through the turbine. In addition, because thermocouples only measure the temperature of gas in direct contact with the thermocouple, temperature variations between thermocouples may be undetected. Moreover, the useful life of the thermocouples may be significantly limited due to the high temperature associated with the gas flow through the turbine.

### BRIEF DESCRIPTION OF THE INVENTION

In a first embodiment, a system includes a wavelength-splitting device configured to optically communicate with an interior of a turbine, and to split an image of the interior of the turbine into a first two-dimensional intensity map of wavelengths indicative of a temperature of a gas and a second two-dimensional intensity map of wavelengths indicative of a temperature of a surface. The system also includes a detector array in optical communication with the wavelength-splitting device. The detector array is configured to output signals indicative of the first and second two-dimensional intensity maps.

In a second embodiment, a system includes an imaging system configured to receive an image of a gas and a surface observable through the gas from an interior of a turbine, to split the image into a first two-dimensional intensity map of wavelengths indicative of a temperature of the gas and a second two-dimensional intensity map of wavelengths indicative of a temperature of the surface, and to output signals indicative of the first and second two-dimensional intensity maps.

In a third embodiment, a method includes receiving an image of a gas and a surface observable through the gas. The method also includes splitting the image into a first two-dimensional intensity map of wavelengths indicative of a temperature of the gas and a second two-dimensional intensity map of wavelengths indicative of a temperature of the surface. The method further includes outputting signals indicative of the first and second two-dimensional intensity maps.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a turbine system including an imaging system configured to capture two-dimensional intensity maps of a gas and a surface observable through the gas in accordance with certain disclosed embodiments of the invention;

FIG. 2 is a cross-sectional view of a turbine section, illustrating various turbine components that may be monitored by the imaging system in accordance with certain disclosed embodiments;

FIG. 3 is a schematic diagram of the imaging system directed toward a gas and a surface observable through the gas in accordance with certain disclosed embodiments;

FIG. 4 is a schematic diagram of the imaging system including multiple detector arrays configured to provide a controller with multiple two-dimensional intensity maps such that the controller may generate a series of temperature map slices and/or a three-dimensional temperature map of the gas in accordance with certain disclosed embodiments; and

FIG. 5 is a flowchart of a method for generating a temperature map of a gas and a temperature map of a surface observable through the gas in accordance with certain disclosed embodiments.

### DETAILED DESCRIPTION OF THE INVENTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments disclosed herein, the articles “a,” “an,” “the,” and “said” are intended to mean that there are one or more of the elements. The terms “comprising,” “including,” and “having” are intended to be inclusive and mean that there may be additional elements other than the listed elements.

Embodiments disclosed herein may enhance turbine operation and maintenance by providing a two-dimensional or three-dimensional temperature map of exhaust gas within the turbine, as well as a two-dimensional temperature map of turbine component surfaces. In one embodiment, an imaging system includes a wavelength-splitting device in optical communication with a viewing port into a turbine. The wavelength-splitting device is configured to split an image of an interior of the turbine into a first two-dimensional intensity map of wavelengths indicative of a temperature of a gas and a second two-dimensional intensity map of wavelengths indicative of a temperature of a surface (e.g., vanes, blades, endwalls, platforms, angel wings, shrouds, etc.). The imaging system also includes a detector array in optical communication with the wavelength-splitting device. The detector array is configured to output respective signals indicative of the first and second two-dimensional intensity maps. In certain embodiments, the imaging system includes a controller configured to generate a first two-dimensional temperature map of the gas and a second two-dimensional temperature map of the surface based on the signals. In further embodiments, the controller is configured to generate a series of two-dimensional temperature map slices through a volume containing the gas, with each slice being oriented perpendicular to a circumferential axis of the turbine. In yet further embodiments, the controller is configured to combine these slices to generate a three-dimensional temperature map of the gas within the volume. The resulting two-dimensional or three-dimensional temperature map of the gas and the two-dimensional temperature map of the surface may be utilized to control the turbine engine during operation and/or assess the remaining useful life of turbine components, thereby increasing the efficiency of turbine operation and maintenance.

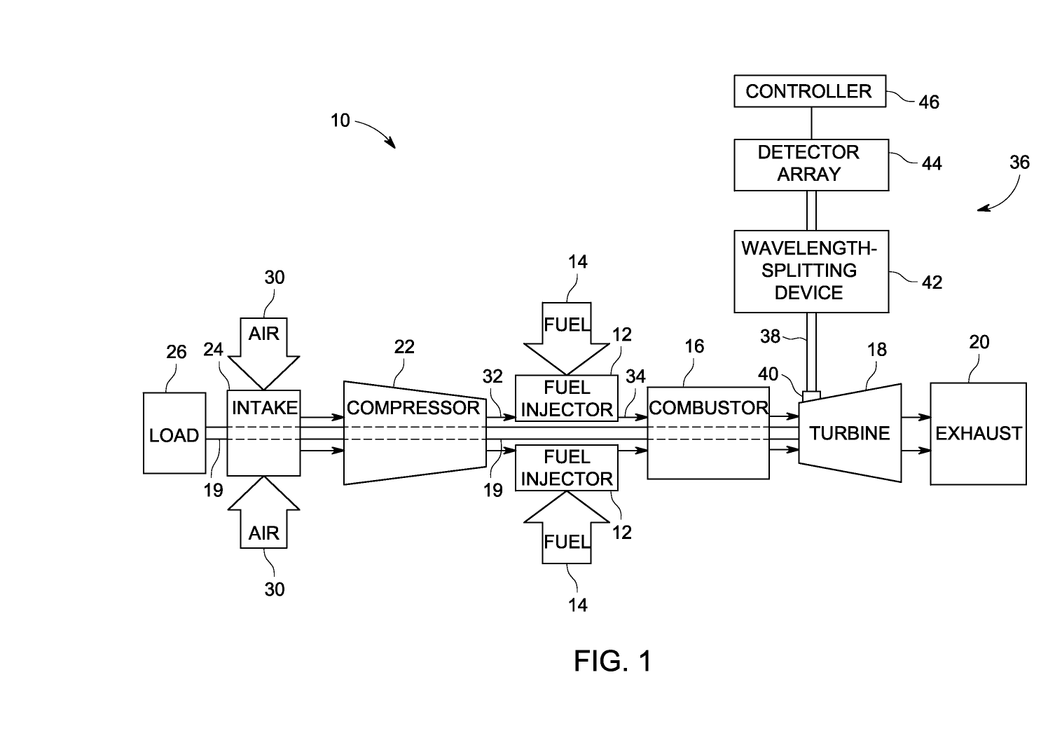

Turning now to the drawings, FIG. 1 is a block diagram of a turbine system 10 including an imaging system configured to capture two-dimensional intensity maps of a gas and a surface observable through the gas. The turbine system 10 includes a fuel injector 12, a fuel supply 14, and a combustor 16. As illustrated, the fuel supply 14 routes a liquid fuel and/or gas fuel, such as natural gas, to the gas turbine system 10 through the fuel injector 12 into the combustor 16. As discussed below, the fuel injector 12 is configured to inject and mix the fuel with compressed air. The combustor 16 ignites and combusts the fuel-air mixture, and then passes hot pressurized exhaust gas into a turbine 18. As will be appreciated, the turbine 18 includes one or more stators having fixed vanes or blades, and one or more rotors having blades which rotate relative to the stators. The exhaust gas passes through the turbine rotor blades, thereby driving the turbine rotor to rotate. Coupling between the turbine rotor and a shaft 19 will cause the rotation of the shaft 19, which is also coupled to several components throughout the gas turbine system 10, as illustrated. Eventually, the exhaust of the combustion process may exit the gas turbine system 10 via an exhaust outlet 20.

A compressor 22 includes blades rigidly mounted to a rotor which is driven to rotate by the shaft 19. As air passes through the rotating blades, air pressure increases, thereby providing the combustor 16 with sufficient air for proper combustion. The compressor 22 may intake air to the gas turbine system 10 via an air intake 24. Further, the shaft 19 may be coupled to a load 26, which may be powered via rotation of the shaft 19. As will be appreciated, the load 26 may be any suitable device that may use the power of the rotational output of the gas turbine system 10, such as a power generation plant or an external mechanical load. For example, the load 26 may include an electrical generator, a propeller of an airplane, and so forth. The air intake 24 draws air 30 into the gas turbine system 10 via a suitable mechanism, such as a cold air intake. The air 30 then flows through blades of the compressor 22, which provides compressed air 32 to the combustor 16. In particular, the fuel injector 12 may inject the compressed air 32 and fuel 14, as a fuel-air mixture 34, into the combustor 16. Alternatively, the compressed air 32 and fuel 14 may be injected directly into the combustor for mixing and combustion.

As illustrated, the turbine system 10 includes an imaging system 36 optically coupled to the turbine 18. In the illustrated embodiment, the imaging system 36 includes an imaging optical system or optical connection 38 (e.g., fiber optic cable, optical waveguide, etc.) extending between a viewing port 40 into the turbine 18 and a wavelength-splitting device 42. While the illustrated viewing port 40 is directed toward an inlet of the turbine 18, it should be appreciated that the viewing port 40 may be positioned at various locations along the turbine 18. As discussed in detail below, the wavelength-splitting device 42 is configured to split an image of an interior of the turbine into a first two-dimensional intensity map of wavelengths indicative of a temperature of a gas and a second two-dimensional intensity map of wavelengths indicative of a temperature of a surface. A detector array 44 optically coupled to the wavelength-splitting device 42 is configured to output respective signals indicative of the first and second two-dimensional intensity maps. In the illustrated embodiment, the detector array 44 is communicatively coupled to a controller 46 which is configured to generate a first two-dimensional temperature map of the gas and a second two-dimensional temperature map of the surface based on the respective signals. As discussed in detail below, the controller 46 may also be configured to generate a series of two-dimensional temperature map slices through a volume containing the gas, with each slice being oriented perpendicular to a circumferential axis of the turbine. In certain embodiments, the controller may be configured to combine these slices to generate a three-dimensional temperature map of the gas within the volume. The resulting two-dimensional or three-dimensional temperature map of the gas may be utilized to control the turbine engine during operation to improve efficiency, reduce emissions and/or increase the useful life of turbine components. In addition, the two-dimensional temperature map of the surface may facilitate monitoring and validation of turbine component performance and/or estimation of the remaining useful life of turbine components.

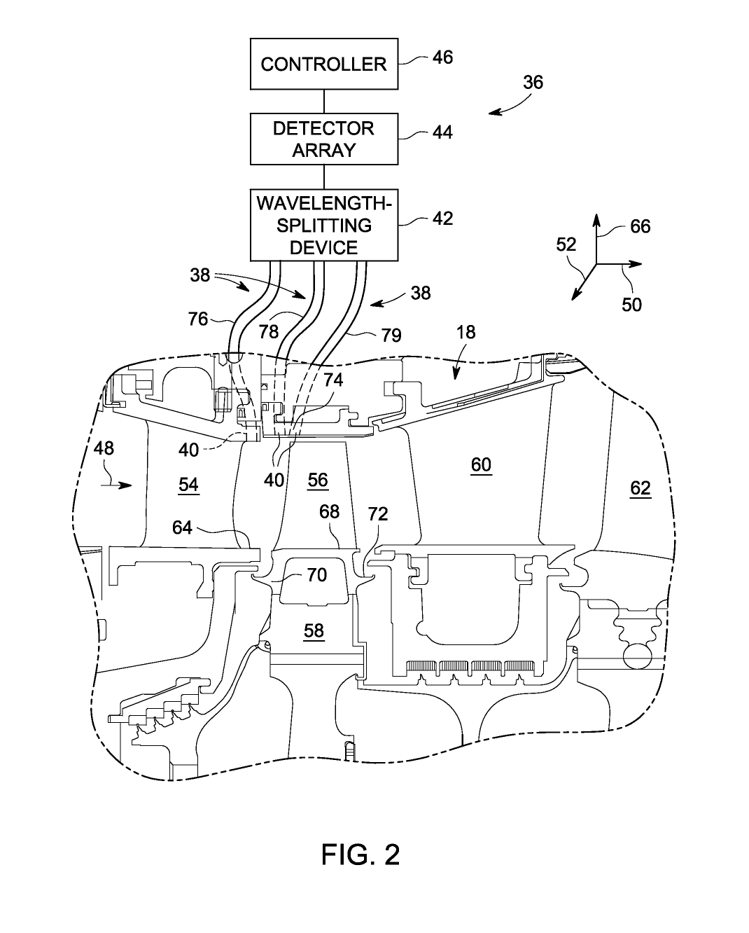

FIG. 2 is a cross-sectional view of a turbine section, illustrating various turbine components that may be monitored by the imaging system 36. As illustrated, exhaust gas/combustion products 48 from the combustor 16 flows into the turbine 18 in an axial direction 50 and/or a circumferential direction 52. The illustrated turbine 18 includes at least two stages, with the first two stages shown in FIG. 2. Other turbine configurations may include more or fewer turbine stages. For example, a turbine may include 1, 2, 3, 4, 5, 6, or more turbine stages. The first turbine stage includes vanes 54 and blades 56 substantially equally spaced in the circumferential direction 52 about the turbine 18. The first stage vanes 54 are rigidly mounted to the turbine 18 and configured to direct combustion gases toward the blades 56. The first stage blades 56 are mounted to a rotor 58 that is driven to rotate by the exhaust gas 48 flowing through the blades 56. The rotor 58, in turn, is coupled to the shaft 19, which drives the compressor 22 and the load 26. The exhaust gas 48 then flows through second stage vanes 60 and second stage blades 62. The second stage blades 62 are also coupled to the rotor 58. As the exhaust gas 48 flows through each stage, energy from the gas is converted into rotational energy of the rotor 58. After passing through each turbine stage, the exhaust gas 48 exits the turbine 18 in the axial direction 50.

In the illustrated embodiment, each first stage vane 54 extends outward from an endwall 64 in a radial direction 66. The endwall 64 is configured to block hot exhaust gas 48 from entering the rotor 58. A similar endwall may be present adjacent to the second stage vanes 60, and subsequent downstream vanes, if present. Similarly, each first stage blade 56 extends outward from a platform 68 in the radial direction 66. As will be appreciated, the platform 68 is part of a shank 70 which couples the blade 56 to the rotor 58. The shank 70 also includes a seal, or angel wing, 72 configured to block hot exhaust gas 48 from entering the rotor 58. Similar platforms and angel wings may be present adjacent to the second stage blades 62, and subsequent downstream blades, if present. Furthermore, a shroud 74 is positioned radially outward from the first stage blades 56. The shroud 74 is configured to minimize the quantity of exhaust gas 48 that bypasses the blades 56. Gas bypass is undesirable because energy from the bypassing gas is not captured by the blades 56 and translated into rotational energy. While the imaging system 36 is described below with reference to monitoring components within the turbine 18 of a gas turbine engine 10, it should be appreciated that the imaging system 36 may be employed to monitor components within other rotating and/or reciprocating machinery, such as a turbine in which steam or another working fluid passes through turbine blades to provide power or thrust. In addition, the imaging system 36 may be utilized to monitor an interior of a reciprocating engine, such as a gasoline or diesel powered internal combustion engine.

As will be appreciated, various components within the turbine 18 (e.g., vanes 54 and 60, blades 56 and 62, endwalls 64, platforms 68, angel wings 72, shrouds 74, etc.) will be exposed to the hot exhaust gas 48 from the combustor 16. Consequently, it may be desirable to measure a temperature of certain components during operation of the turbine 18 to ensure that the temperature remains within a desired range and/or to monitor thermal stress within the components. For example, the imaging system 36 may be configured to determine a two-dimensional temperature map of the first stage turbine blades 56. As will be appreciated, the two-dimensional temperature map may be utilized to determine a temperature gradient across each blade 56, thereby facilitating computation of thermal stress within the blade 56.

In addition, it may be desirable to monitor a temperature of the exhaust gas 48 passing through the turbine 18. As will be appreciated, accurate gas temperature monitoring may facilitate adjustment of gas turbine parameters to increase turbine efficiency, reduce emissions and/or increase the useful life of components in contact with the exhaust gas. As discussed in detail below, the imaging system 36 is configured to generate a two-dimensional temperature map of the exhaust gas 48 adjacent to the first stage turbine blades 56. In certain embodiments, the controller 46 may also be configured to generate a series of two-dimensional temperature map slices through a volume containing the gas, with each slice being oriented perpendicular to the circumferential axis 52 of the turbine 18. In addition, the controller may be configured to combine these slices to generate a three-dimensional temperature map of the gas within the volume.

The illustrated embodiment includes three optical connections 38 to optically couple the viewing ports 40 to the wavelength-splitting device 42. As illustrated, a first optical connection 76 is coupled to a viewing port 40 positioned upstream of the blade 56 and angled toward the blade 56, a second optical connection 78 is coupled to another viewing port 40 positioned downstream from the first viewing port and substantially aligned with the radial direction 66, and a third optical connection 79 is coupled to a third viewing port 40 positioned downstream from the second viewing port and angled in an upstream direction. In this configuration, the first optical connection 76 will convey an image of the blade 56 and the exhaust gas 48 positioned upstream of the blade 56 to the wavelength-splitting device 42. In addition, the second and third optical connections 78 and 79 will convey images of other perspectives of the exhaust gas 48 to the wavelength-splitting device 42. As discussed in detail below, the controller 46 may utilize images of the exhaust gas 48 taken from different perspectives to create multiple two-dimensional temperature map slices and/or a three-dimensional temperature map of the exhaust gas 48.

As will be appreciated, the viewing ports 40 may be angled in the axial direction 50, circumferential direction 52 and/or radial direction 66 to direct the viewing ports 40 toward desired regions of the blade 56 and/or exhaust gas 48 adjacent to the blade 56. In alternative embodiments, more or fewer viewing ports 40 and optical connections 38 may be employed to obtain images of the first stage blade 56 and/or gas adjacent to the blade. For example, certain embodiments may employ 1, 2, 3, 4, 5, 6, 7, 8, or more viewing ports 40 and a corresponding number of optical connections 38 to convey images of the blade 56 and exhaust gas 48 to the wavelength-splitting device 42. As discussed in detail below, more accurate two-dimensional temperature map slices and/or three-dimensional temperature maps may be generated with additional perspectives taken from more viewing ports 40 and optical connections 38. As previously discussed, the optical connections 38 may include a fiber optic cable or an optical imaging system (e.g., a rigid imaging optical waveguide system), for example. It should also be appreciated that certain embodiments may omit the optical connections 38, and the wavelength-splitting device 42 may be directly optically coupled to the viewing ports 40.

While the viewing ports 40 are directed toward the first stage blades 56 and the exhaust gas 48 located upstream of the blades 56 in the illustrated embodiment, it should be appreciated that the viewing ports 40 may be directed toward other turbine components and/or other regions of exhaust gas flow in alternative embodiments. For example, one or more viewing ports 40 may be directed toward the first stage vanes 54, the second stage vanes 60, the second stage blades 62, the endwalls 64, the platforms 68, the angel wings 72, the shrouds 74, or other components within the turbine 18. Such configurations may capture images of the exhaust gas 48 and the component observable through the exhaust gas 48. Further embodiments may include viewing ports 40 directed toward multiple components within the turbine 18 and/or multiple regions of exhaust gas flow. Similar to the first stage blades 56, the imaging system 36 may generate a two-dimensional temperature map for each component within a field of view of a viewing port 40, as well as a two-dimensional temperature map of the exhaust gas 48 located between the component and the viewing port 40. In this manner, thermal stress within various turbine components and/or exhaust gas temperature adjacent to the components may be measured, thereby providing an operator with data that may be used to adjust operational parameters of the turbine system 10 and/or to determine maintenance intervals.

As previously discussed, the optical connections 38 (e.g., fiber optic cable, optical waveguide, etc.) convey an image of the turbine interior to the wavelength-splitting device 42. The wavelength-splitting device 42, in turn, is configured to split the image into a first two-dimensional intensity map of wavelengths indicative of a temperature of the exhaust gas 48 and a second two-dimensional intensity map of wavelengths indicative of a temperature of a turbine component. The detector array 44 optically coupled to the wavelength-splitting device 42 is configured to output a signal or signals indicative of the first and second two-dimensional intensity maps. The detector array 44 may be configured to capture multiple images over a period of time. As will be appreciated, certain turbine components, such as the first stage blades 56 described above, may rotate at high speed along the circumferential direction 52 of the turbine 18. Consequently, to capture an image of such components, the detector array 44 may be configured to operate at a frequency sufficient to provide the controller 46 with a substantially still image of each component. For example, in certain embodiments, the detector array 44 may be configured to output the signals indicative of the two-dimensional intensity map of each image at a frequency greater than approximately 100,000, 200,000, 400,000, 600,000, 800,000, or 1,000,000 Hz, or more. In further embodiments, the detector array 44 may be configured to output the signals indicative of the two-dimensional intensity map of each image with an integration time of approximately 10, 5, 3, 2, 1, or 0.5 microseconds, or less. In this manner, a two-dimensional temperature map may be generated for each rotating turbine component.

Furthermore, it should be appreciated that the exhaust gas 48 rotates in the circumferential direction 52 as the gas moves in the downstream axial direction through the turbine 18. Consequently, the detector array 44 may be configured to operate at a frequency sufficient to provide the controller 46 with a substantially still image of the exhaust gas 48. As discussed in detail below, each series of images taken of the exhaust gas 48 at a particular time may be utilized to generate a two-dimensional temperature map slice via tomographic techniques. As the exhaust gas 48 rotates in the direction 52, subsequent slices may be generated, thereby establishing a series of two-dimensional temperature map slices that may be combined to create a three-dimensional temperature map of the exhaust gas 48.

In certain embodiments, the optical connections 38 may be coupled to a multiplexer within the wavelength-splitting device 42 to provide the detector array 44 with images from each observation point. As will be appreciated, images from each optical connection 38 may be multiplexed in space or time. For example, if the multiplexer is configured to multiplex the images in space, each image may be projected onto a different portion of the detector array 44. In this configuration, an image from the first optical connection 76 may be directed toward a first portion (e.g., first third) of the detector array 44, an image from the second optical connection 78 may be directed toward a second portion (e.g., second third) of the detector array 44, and an image from the third optical connection 79 may be directed toward a third portion (e.g., third third). As a result, the detector array 44 may capture each image at one-third resolution. In other words, spatial resolution is inversely proportional to the number of spatially multiplexed signals. As will be appreciated, lower resolution provides the controller 46 with less spatial coverage of the turbine component and/or exhaust gas 48 than higher resolution. Therefore, the number of spatially multiplexed signals may be limited by the minimum resolution sufficient for the controller 46 to establish a desired two-dimensional temperature map of the turbine component and/or a desired two-dimensional or three-dimensional temperature map of the exhaust gas 48.

Alternatively, images provided by the optical connections 38 may be multiplexed in time. For example, the detector array 44 may alternately capture an image from each optical connection 38 using the entire resolution of the detector array 44. Using this technique, the full resolution of the detector array 44 may be utilized, but the capture frequency may be reduced proportionally to the number of observation points scanned. For example, if two observation points are scanned and the detector array frequency is 100,000 Hz, the detector array 44 is only able to scan images from each observation point at 50,000 Hz. Therefore, the number of temporally multiplexed signals may be limited by the desired scanning frequency. In addition, capturing images of the exhaust gas 48 from different perspectives at substantially different times may reduce the accuracy of the two-dimensional temperature map slices.

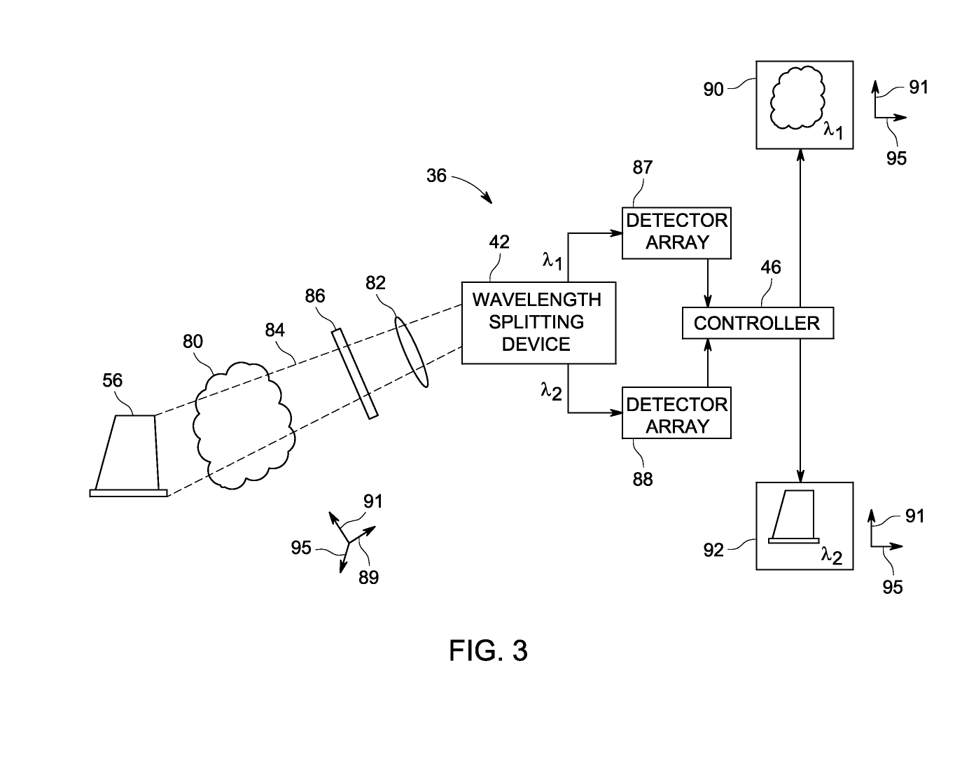

FIG. 3 is a schematic diagram of the imaging system 36 directed toward a gas 80 (e.g., exhaust gas 48) and a surface, such as the illustrated turbine blade 56, observable through the gas 80. In the illustrated embodiment, the wavelength-splitting device 42 is directed toward the first stage blades 56. However, it should be appreciated that the wavelength-splitting device 42 may be directed toward other turbine components (e.g., vanes 54 and 60, blades 62, endwalls 64, platforms 68, angel wings 72, shrouds 74, etc.) in alternative embodiments. As will be appreciated, electromagnetic radiation may be emitted from the blade 56 and the gas 80. This electromagnetic radiation may, in turn, be captured by the imaging system 36 as an image (e.g., a combined image of the wavelengths emitted by the blade 56 and not absorbed by the gas 80, and wavelengths emitted by the gas 80). Such an image may include radiation having a wavelength within the infrared, visible and/or ultraviolet regions of the electromagnetic spectrum.

As illustrated, a lens 82 is positioned between the wavelength-splitting device 42 and the gas 80. The lens 82 is configured to focus the radiation emitted by the blade 56 and the gas 80 onto the wavelength-splitting device 42. As will be appreciated, the lens 82, or series of lenses 82, will establish a field of view 84 covering at least a portion of the first stage blade 56, or other desired turbine components. The field of view 84 will also be affected by the position of the wavelength-splitting device 42 relative to the turbine component and/or the configuration of the optical connection 38, if present. By selecting an appropriate lens 82 and/or properly positioning the wavelength-splitting device 42, a desired field of view 84 may be established, thereby enabling the imaging system 36 to capture a two-dimensional image of the gas 80 and the turbine component observable through the gas 80. The illustrated embodiment also includes a filter 86 positioned between the lens 82 and the gas 80. The filter 86 may be a low-pass filter, a high-pass filter or a band-pass filter configured to reduce the wavelength range of radiation received by the imaging system 36. For example, the filter 86 may be configured to facilitate passage of radiation having a wavelength range approximately between 1 to 5 microns. Such a wavelength range may be well-suited for turbine component and exhaust gas temperature measurement. In alternative embodiments, the filter 86 may be omitted or combined with the lens 82.

As previously discussed, the imaging system 36 is configured to capture a two-dimensional intensity profile of wavelengths indicative of a temperature of the gas 80 and a two-dimensional intensity profile of wavelengths indicative of a temperature of the blade 56. As will be appreciated, the blade 56 will emit radiation over a wide range of wavelengths as the temperature of the blade increases. In addition, certain combustion products species, such as water vapor and carbon dioxide, absorb and emit radiation over a wide range of wavelengths in response to increased temperature. As a result, during operation of the gas turbine engine 10, only a fraction of wavelengths emitted by the blade 56 reach the imaging system 36 with sufficient intensity and negligible interference for accurate intensity measurement. Consequently, the imaging system 36 may be configured to measure the intensity of certain wavelengths which are more likely to pass through the gas 80 without significant absorption or interference to determine the temperature of the blade 56. For example, wavelengths within the red portion of the visible spectrum and/or within the near infrared spectrum may pass through the gas 80 with less absorption than other frequency ranges. Therefore, certain embodiments may utilize such frequency ranges for determining the temperature of the blade 56. For example, certain imaging systems 36 may be configured to measure the intensity of wavelengths within a range of approximately 0.5 to 1.4 microns, 1.5 to 1.7 microns, and/or 2.1 to 2.4 microns to determine blade temperature. However, it should be appreciated that alternative embodiments may measure an intensity of electromagnetic radiation within other portions of the visible, infrared and/or ultraviolet spectra.

Similarly, the imaging system 36 may be configured to measure the intensity of certain wavelengths emitted by the gas 80 for gas temperature determination. For example, the intensity of radiation emitted by the gas 80 within a wavelength range of approximately 1.4 to 1.5 microns, 1.7 to 2.1 microns, 2.4 to 3 microns, and/or 4 to 5 microns may be significantly higher than the intensity of radiation emitted by the blade 56 within the same wavelength ranges. Consequently, the imaging system 36 may be configured to measure the intensity of wavelengths within this range to determine the temperature of the gas 80. However, because exhaust gas species may vary, alternative embodiments may measure an intensity of electromagnetic radiation within other portions of the visible, infrared and/or ultraviolet spectra.

In the illustrated embodiment, the wavelength-splitting device 42 is configured to split the image of the gas 80 and the turbine blade 56 observable through the gas 80 into a first two-dimensional intensity map of wavelengths λ₁ indicative of a temperature of the gas 80 and a second two-dimensional intensity map of wavelengths λ₂ indicative of a temperature of the blade 56. It should be appreciated that the wavelengths denoted by λ₁ and λ₂ may represent a continuous range of wavelengths or groups of discrete wavelengths distributed across the electromagnetic spectrum. In embodiments in which the wavelengths λ₁ and/or λ₂ represent multiple discontinuous groups of wavelength ranges, the wavelength-splitting device 42 may be configured to split the image into the desired ranges and then to combine certain ranges to form the groups denoted by λ₁ and λ₂.

The wavelength-splitting device 42 may include any suitable mechanism configured to separate the image of the gas 80 and the blade 56 into the first intensity map of wavelengths λ₁ and the second intensity map of wavelengths λ₂. For example, the wavelength-splitting device 42 may include one or more dichroic minors configured to convert the image into the first and second intensity maps. As will be appreciated, dichroic mirrors include a reflective surface configured to reflect radiation of a desired wavelength range, while allowing the remaining radiation to pass through. In certain embodiments, a first dichroic minor may be configured to reflect radiation having wavelengths λ₁, while allowing the remaining wavelengths to pass through. The remaining wavelengths may then be directed toward a second dichroic minor configured to reflect radiation having wavelengths λ₂. As will be appreciated, the range of wavelengths reflected by the dichroic mirror may be particularly selected based on the coating applied to the mirror.

In further embodiments, the wavelength-splitting device 42 may include an image splitter and multiple filters to convert the image into the first and second intensity maps. For example, the image splitter may include a series of lenses, prisms, minors and/or other reflective and/or refractive optics to split the image into multiple duplicate images, each having substantially similar spectral content (e.g., range of wavelengths). One duplicate image may be directed through a first filter configured to facilitate passage of radiation having wavelengths λ₁, and another duplicate image may be directed through a second filter configured to facilitate passage of radiation having wavelengths λ₂. Further embodiments may employ a multichannel wavelength separation prism to directly separate the image into the desired first and second intensity maps. Yet further embodiments may utilize a filter mask having multiple narrow wavelength band filters, where each narrow wavelength band filter is in optical communication with respective detector elements of the detector array.

Once the image has been split into the desired wavelength ranges, the first two-dimensional intensity map is directed toward a first detector array 87, and the second two-dimensional intensity map is directed toward a second detector array 88. Each detector array 87 and 88 is configured to output a signal or signals to the controller 46 indicative of the respective two-dimensional intensity map. While two detector arrays 87 and 88 are employed in the present embodiment, it should be appreciated that a single detector array may be utilized to receive both two-dimensional intensity maps. For example, each intensity map may be projected onto a non-overlapping portion of the array, or the detector array may be configured to selectively receive each intensity map in an alternating manner.

As previously discussed, the controller 46 is configured to generate a first two-dimensional temperature map of the gas and a second two-dimensional temperature map of the surface based on the signals from the detector arrays 87 and 88. For example, temperature of a gas or a component may be determined by measuring the intensity of electromagnetic radiation emitted by the object at a particular wavelength. For example, assuming emissivity is one (Black Body assumption), Planck's Law may be utilized to compute temperature from a measured radiation intensity. However, because actual components may have an emissivity less than one, the controller 46 may utilize a constant emissivity value based on experimental observation and/or computation. By computing temperature at each point within the first two-dimensional intensity map, the controller 46 may generate a two-dimensional temperature map 90 of the gas 80. Because the image is taken along a plane substantially perpendicular to a direction 89 of the field of view 84, the first two-dimensional temperature map 90 represents an integrated gas temperature map of a plane defined by a radial axis 91 and a circumferential axis 95. In other words, each point within the first temperature map 90 represents the path-averaged gas temperature along the direction 89. Similarly, by computing temperature at each point within the second two-dimensional intensity map, the controller 46 may generate a two-dimensional temperature map 92 of the blade 56. As previously discussed, the temperature maps 90 and 92 may be utilized to control the turbine engine during operation and/or assess the remaining useful life of turbine components, thereby increasing the efficiency of turbine operation and maintenance.

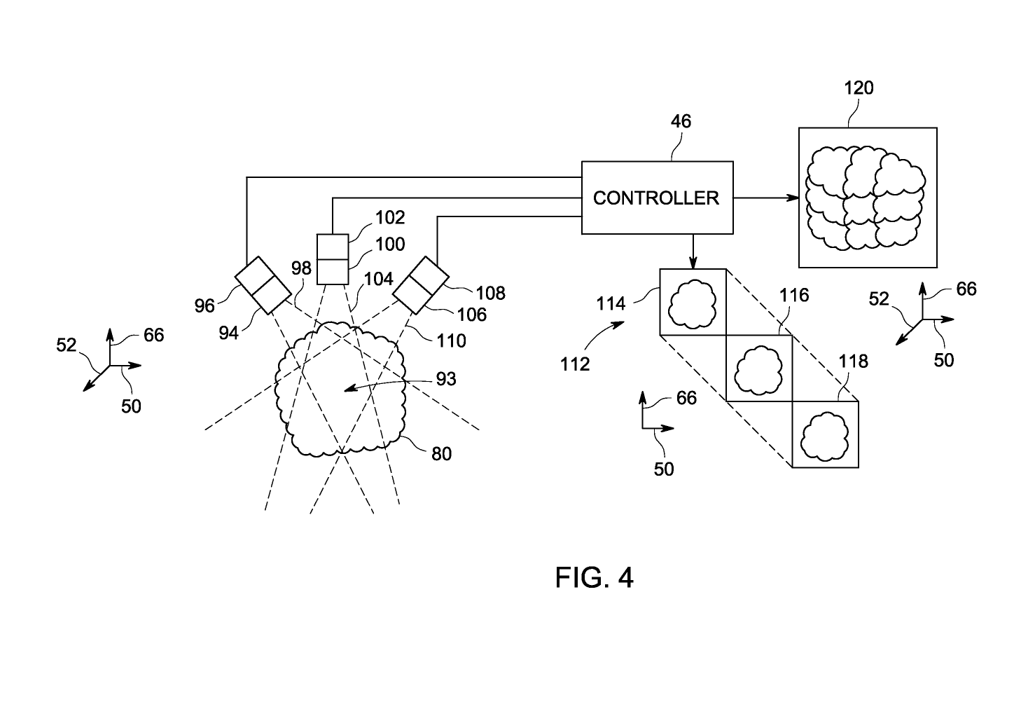

FIG. 4 is a schematic diagram of the imaging system 36 including multiple detector arrays configured to provide the controller 46 with multiple two-dimensional intensity maps such that the controller 46 may generate a series of temperature map slices and/or a three-dimensional (i.e., volumetric) temperature map of the gas 80. As illustrated, multiple wavelength-splitting device/detector array assemblies are directed toward a volume 93 containing the gas 80. Specifically, a first wavelength-splitting device 94 is coupled to a first detector array 96, and the assembly is positioned upstream of the volume 93 along the axial direction 50. As illustrated, a first field of view 98 of the first wavelength-splitting device 94 is angled in the downstream direction toward the volume 93. In addition, a second wavelength-splitting device 100 is coupled to a second detector array 102, and the assembly is positioned outward from the volume 93 along the radial direction 66. As illustrated, a second field of view 104 of the second wavelength-splitting device 100 is directed radially downward toward the volume 93. Furthermore, a third wavelength-splitting device 106 is coupled to a third detector array 108, and the assembly is positioned downstream from the volume 93 along the axial direction 50. As illustrated, a third field of view 110 of the third wavelength-splitting device 106 is angled in the upstream direction toward the volume 93. In this configuration, the fields of view 98, 104 and 110 overlap within the volume 93.

In the illustrated embodiment, each detector array 96, 102 and 108 is communicatively coupled to the controller 46 and configured to output a signal or signals indicative of the two-dimensional intensity map of wavelengths indicative of gas temperature. Furthermore, the controller 46 is configured to receive the signals and to generate multiple two-dimensional temperature maps of the gas 80 within the volume 93. For example, the controller 46 may generate a two-dimensional temperature map of the gas 80 along a plane perpendicular to the field of view of each assembly, similar to the configuration described above with reference to FIG. 3. In further embodiments, the controller 46 may generate a series 112 of two-dimensional temperature map slices through the volume 93 based on the signals. Such an embodiment may provide enhanced data regarding the temperature distribution within the gas 80, thereby facilitating more efficient operation of the turbine engine 10.

For example, the controller 46 may utilize tomographic techniques to mathematically compute a two-dimensional temperature map of the gas 80 within a plane perpendicular to the circumferential direction 52. In such embodiments, each detector array 96, 102 and 108 will receive a two-dimensional intensity map of the gas 80 along a plane perpendicular to the respective field of view at a first time. The controller 46 may utilize these intensity maps to generate a first slice 114 through the volume 93 using various tomographic techniques, such as finite expansion reconstruction methods, Algebraic Reconstruction Techniques (ART), Maximum Likelihood-Expectation Maximization (ML-EM), iterative reconstruction, statistical reconstruction techniques, or other suitable reconstruction techniques.

As previously discussed, the gas 80 may rotate in the circumferential direction 52 through the turbine 18. Consequently, a second two-dimensional temperature map slice 116 through the volume 93 may be computed by capturing two-dimensional intensity maps at a second time, and a third slice 118 may be computed by capturing two-dimensional intensity maps at a third time. As previously discussed, the integration time may be shorter than approximately 10, 5, 3, 2, 1, or 0.5 microseconds, or less, and the two-dimensional intensity maps may be captured at a frequency greater than approximately 100,000, 200,000, 400,000, 600,000, 800,000, or 1,000,000 Hz, or more. As a result, the series of slices 112 may provide an accurate reconstruction of the temperature distribution within the gas 80. Furthermore, the high frequency and short integration time, combined with various three-dimensional tomographic techniques, may enable the controller 46 to generate a three-dimensional temperature map 120 of the gas 80 within the volume 93. The resulting three-dimensional temperature map 120 of the gas may be utilized to control the turbine engine during operation to improve efficiency, reduce emissions and/or increase the useful life of turbine components.

While three wavelength-splitting device/detector array assemblies are included in the illustrated embodiment, it should be appreciated that more or fewer assemblies may be employed in alternative embodiments. For example, certain embodiments may include 2, 3, 4, 5, 6, 7, 8, 9, 10 or more assemblies to capture different perspectives of the volume 93. As will be appreciated, a more precise reconstruction of the temperature distribution within the volume 93 may be produced with a greater number of assemblies. In further embodiments, multiple wavelength-splitting devices may be optically coupled to a single detector array including a multiplexer to simultaneously or sequentially capture images from each wavelength-splitting device. In yet further embodiments, multiple optical connections 38 extending from multiple viewing ports 40 to a single wavelength-splitting device may be employed to capture each two-dimensional intensity map, such as the configuration illustrated in FIG. 2.

Alternative embodiments may employ a single directable wavelength-splitting device/detector array assembly to capture each two-dimensional intensity map used to generate the two-dimensional temperature map slices. For example, in certain embodiments, the assembly may be movable between multiple positions to capture multiple perspectives of the gas 80 within the volume 93. In further embodiments, the assembly may include a moveable/rotatable reflective or refractive device (e.g., mirror, prism, etc.) to direct a stationary assembly toward different regions of the gas 80 within the volume 93. Due to the speed at which the gas 80 is rotating along the circumferential direction 52, the delay associated with redirecting the assembly may result in inaccurate computation of the slices 112. Consequently, the controller 46 may be configured to instruct the detector array to capture images during subsequent rotations of the gas 80. For example, the rotation rate of the gas 80 may be substantially similar to the rotation rate of the turbine blades 56. Consequently, the controller 46 may instruct the detector array to capture an image of the gas 80 when a particular blade is positioned adjacent to the array. The controller 46 may then redirect the assembly toward a second region of the gas 80. When the particular blade returns to the position adjacent to the array, the controller 46 may instruct the detector array to capture a second image. This technique may be repeated to capture multiple perspectives of the gas 80 with a single assembly. After each two-dimensional intensity map has been captured, the controller 46 may construct a temperature map slice as described above. Additional slices may be generated by repeating the technique for other blade positions.

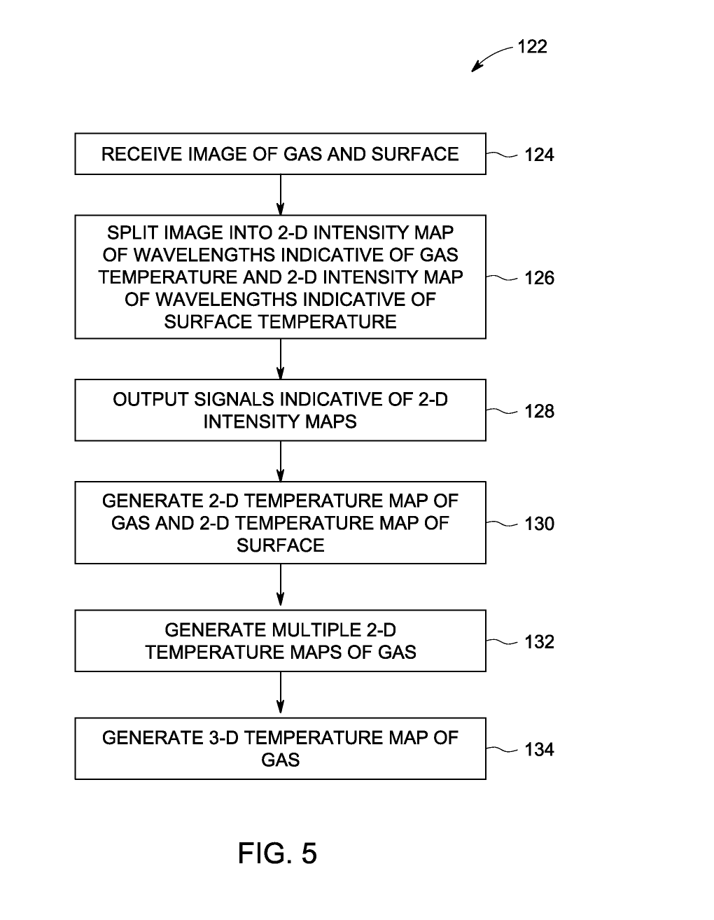

FIG. 5 is a flowchart of a method 122 for generating a temperature map of a gas and a temperature map of a surface observable through the gas. First, as represented by block 124, an image of the gas and the surface observable through the gas is received. As previously discussed, the image may be received from an interior of the turbine 18 via a viewing port 40 and optical connection 38. In such a configuration, the gas will include exhaust gas 48 flowing through the turbine 18, and the surface will include a turbine component. Next, the image is split into a first two-dimensional intensity map of wavelengths indicative of gas temperature and a second two-dimensional intensity map of wavelengths indicative of surface temperature, as represented by block 126. Such a splitting operation may be performed by the wavelength-splitting device 42 in optical communication with the viewing port 40 into the turbine 18. Signals indicative of the first and second two-dimensional intensity maps is then output, as represented by block 128. For example, the wavelength-splitting device 42 may be in optical communication with one or more detector arrays configured to receive the intensity maps and output a respective signal.

In certain embodiments, a first two-dimensional temperature map of the gas and a second two-dimensional temperature map of the surface are generated, as represented by block 130. For example, the detector arrays may be communicatively coupled to the controller 46, and the controller 46 may be configured to receive the signals and generate the two-dimensional temperature maps based on the detected intensity of the selected wavelengths. In further embodiments, multiple two-dimensional temperature maps of the gas may be generated, as represented by block 132. For example, the imaging system 36 may include multiple wavelength-splitting device/detector array assemblies, and the controller 46 may generate a two-dimensional temperature map of the gas along a plane perpendicular to a field of view of each assembly. In further embodiments, the controller 46 may generate a series of two-dimensional temperature map slices through the gas using tomographic techniques. Finally, as represented by block 134, a three-dimensional temperature map of the gas may be generated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a wavelength-splitting device configured to optically communicate with an interior of a turbine, and to split an image of the interior of the turbine into a first two-dimensional intensity map of wavelengths indicative of a temperature of a gas and a second two-dimensional intensity map of wavelengths indicative of a temperature of a surface; and
a detector array in optical communication with the wavelength-splitting device, wherein the detector array is configured to output signals indicative of the first and second two-dimensional intensity maps.

2. The system of claim 1, comprising a controller communicatively coupled to the detector array, wherein the controller is configured to generate a first two-dimensional temperature map of the gas and a second two-dimensional temperature map of the surface based on the signals.

3. The system of claim 2, wherein the controller is configured to generate a plurality of first two-dimensional temperature maps based on the signals via tomographic techniques.

4. The system of claim 3, wherein each two-dimensional temperature map comprises a slice through a volume containing the gas, and wherein each slice is oriented perpendicular to a circumferential axis of the turbine.

5. The system of claim 4, wherein the controller is configured to generate a three-dimensional temperature map of the gas within the volume from the plurality of slices.

6. The system of claim 1, wherein the detector array is configured to output the signals at a frequency greater than approximately 100,000 Hz.

7. The system of claim 1, wherein the wavelengths indicative of the temperature of the gas are between approximately 1.4 to 5 microns, and the wavelengths indicative of the temperature of the surface are between approximately 0.5 to 2.4 microns.

8. The system of claim 1, wherein the wavelength-splitting device is configured to optically couple to a viewing port into the turbine via a fiber optic cable or an imaging optical system.

9. The system of claim 1, wherein the surface comprises a blade, a vane, an endwall, a platform, an angel wing, or a shroud.

10. A system comprising:
an imaging system configured to receive an image of a gas and a surface observable through the gas from an interior of a turbine, to split the image into a first two-dimensional intensity map of wavelengths indicative of a temperature of the gas and a second two-dimensional intensity map of wavelengths indicative of a temperature of the surface, and to output signals indicative of the first and second two-dimensional intensity maps.

11. The system of claim 10, wherein the imaging system is configured to generate a first two-dimensional temperature map of the gas and a second two-dimensional temperature map of the surface based on the signals.

12. The system of claim 10, wherein the imaging system is configured to output the signals indicative of the first and second two-dimensional intensity maps with an integration time shorter than approximately 10 microseconds.

13. The system of claim 10, wherein the imaging system is optically coupled to the turbine by a fiber optic cable or an imaging optical system.

14. The system of claim 10, wherein the imaging system is configured to receive a plurality of images of the gas and the surface, and to generate a plurality of first two-dimensional temperature maps of the gas.

15. The system of claim 14, wherein the imaging system is configured to generate a three-dimensional temperature map of the gas from the plurality of first two-dimensional temperature maps.

16. A method comprising:
receiving an image of a gas and a surface observable through the gas;
splitting the image into a first two-dimensional intensity map of wavelengths indicative of a temperature of the gas and a second two-dimensional intensity map of wavelengths indicative of a temperature of the surface; and
outputting signals indicative of the first and second two-dimensional intensity maps.

17. The method of claim 16, comprising generating a first two-dimensional temperature map of the gas and a second two-dimensional temperature map of the surface based on the signals.

18. The method of claim 16, comprising generating a plurality of first two-dimensional temperature maps of the gas based on the signals.

19. The method of claim 18, comprising generating a three-dimensional temperature map of the gas from the plurality of first two-dimensional temperature maps.

20. The method of claim 16, wherein receiving the image of the gas and the surface observable through the gas comprises receiving the image from an interior of a turbine.
